(19) United States
(12) Patent Application Publication
(10) Pub. No.: US 2004/0267640 A1
(43) Pub. Date: Dec. 30, 2004

(54) Inventory management utilizing unattended pick up and return systems with a service parts facility

(75) Inventors: Juwono W. Bong, Lawrenceville, GA (US); Robert F. Joyce, Alpharetta, GA (US); Clyde W. Knowles, Woodstock, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 10/607,375

(22) Filed: Jun. 26, 2003

(51) Int. Cl. G06F 17/60

(52) U.S. Cl. 705/28

(57) ABSTRACT

An unattended distribution facility and an unattended returns facility are incorporated into or are proximate to an attended distribution and return facility operated by an inventory management service. The unattended distribution facility and unattended returns facility are accessible by customers at times when the attended distribution and return facility are unavailable or at times when long waits are required to receive or return items at the attended distribution and return facility because of the number of customers simultaneously trying to obtain or return items. An embodiment includes incorporating the unattended returns facility into the unattended distribution facility. An unattended distribution facility's electronic control system is integrated into an inventory management system used by the inventory management service so that the location of items placed in the unattended distribution facility may be monitored and information about the item may be updated when it is picked up by a customer.

### BACKGROUND OF THE INVENTION

1 Field of the Invention

The present invention relates generally to inventory management systems utilizing service parts facilities for the distribution of inventory items and the return of items. Particularly, it relates to inventory management utilizing unattended secure facilities concurrently with attended facilities and more specifically to systems and methods for the distribution of service parts from a supplier to a user and for the return of parts from the user to a supplier or other entities utilizing unattended facilities concurrently with attended facilities.

2. Description of Related Art

Inventory management services contract with organizations to manage the service parts inventory for the organization. For instance, technician's employed by a service organization may obtain parts from an inventory management service for their various activities and may return unused, replaced or damaged parts to the inventory management service. Such services are challenged to economically and efficiently get the parts into the hands of the technicians without unduly delaying their repair duties or incurring extraordinary expenses. Furthermore, the return of parts may be a time-consuming, inefficient use of a technician's resources.

In many instances, technicians will travel to a service parts facility operated by the inventory management service in order to pick-up and/or drop off parts. The facilities may include forward stocking facilities (FSFs) and independent unattended facilities (UFs). The use of an UFs in inventory management has been disclosed in U.S. patent application Ser. No. 10/285,115, filed on Oct. 31, 2002, by Knowles et al., and U.S. patent application Ser. No. 10/401,915, filed Mar. 28, 2003 by Bong et al., both of which are assigned to UPS (f/k/a United Parcel Service of America, Inc.), the assignee of this application.

Distribution centers (DCs) are commonly used to supply inventory items to the FSFs and UFs. DCs may also be referred to as central warehouses (CWs). In many instances, DCs are located such that an order for an inventory item may be placed and relayed to a DC as late as, for example, 11:00 p.m. and delivered to an FSF or UF by, for example, 9:30 a.m. the next morning by the use of overnight parcel delivery services. This is often referred to as an “end of runway” location as the DC may be located close to an overnight parcel delivery service's air transportation facility. Generally, DCs are larger facilities containing a more extensive inventory of parts than FSFs, but do not directly distribute or receive return items from customers or technicians on site, whereas FSFs are smaller facilities located closer to a customer where the inventory may be more limited and more narrowly tailored to the needs of the nearby customers.

FSFs are often staffed with personnel of the inventory management service who distribute items directly to technicians and customers and receive return items from such persons. FSFs may also be referred to as field stocking locations (FSLs), field stocking banks (FSBs), and supply or service depots (SDs). Often the pick-up transactions occur in the morning as the technicians begin their workday and the return transaction occur in the afternoons as the technicians end the workday. Generally, FSFs have walk-up service areas (generally, windows) whereby technicians request and receive their parts from inventory management service personnel or return parts to an inventory management service employee. Reliance upon these service windows only by inventory management services has created challenges in quickly and efficiently exchanging parts with technicians. During peak times (usually mornings and late afternoons), these transactions may become extraordinarily time-consuming as numerous technicians simultaneously converge upon the windows in order to obtain or return parts.

The pick-up window at a FSF is used to serve technicians who come to pick-up and/or return parts. Common to such face-to-face interactions, a high level of customer service is expected from the FSF personnel serving at the window. Meanwhile, at the backend, FSF personnel are expected to be quick in handling parts, managing inventory, or any other warehouse tasks. These two different expectations require functions that have differing characteristics and may not be easily combined or run by the same group of people. However, creating two separate functions, customer service and warehousing, may not be a cost effective solution, especially in a relatively small environment like an FSF.

Typically, there are peak hours when queue at the window is expected to be the longest. Usually, the first peak happens in the morning as technicians start the day by picking up parts needed for that day and/or returning parts from previous day. Later in the afternoon, the second peak could happen when technicians either pick parts for their next jobs and/or return parts from their morning jobs. These peak hours pose a challenge for staffing the FSF window. While more personnel are required during the peak hours, not as many are needed when the window activity has slowed down. These slow periods may result in personnel that need to be assigned to other tasks, else they become idle resources. Furthermore, this situation may be exacerbated by FSFs that provide parts to more than one service organization (a multi-client FSF). Large, high-volume service organizations may require FSF personnel that are specially trained and familiar with that particular service organization's parts and inventory systems. In such situations, there may be separate personnel assigned to each service organization transacting with technicians at the same time.

During low activity hours, FSF personnel usually work on other tasks. For example, in the morning right after the delivery of parts from a third-party vendor, a DC or another FSF, FSF personnel may be busy making cross-dock orders available for technicians as well as pulling orders from inventory requested for that morning's pick-up by technicians. Cross-dock orders are ordered items that are received by the FSF and immediately made available for pick-up by the ordering customer without such items having first been entered into the physical inventory of the receiving FSF. After the morning's peak hours, FSF personnel will work on warehouse tasks such as processing replenishment stock delivered that day or processing return parts. In some instances the FSF personnel may be receiving parts from delivery services that try to minimize their time at each delivery location. And, in some instances, the inventory management service may have self-imposed guidelines or commitments to service organizations to have received parts ready for distribution within a certain time period after receipt (e.g., one hour). When a technician comes to pick-up or return parts, the FSF personnel must then go to the window and provide the service requested. This creates a distraction from the FSF personnels' current task and time is lost providing service to the technician from the window. In some instances, the delivery service may leave and attempt delivery at another time. The inventory management service may incur a cost premium for not accepting delivery on the first delivery attempt. Furthermore, to prevent the delays in receiving and/or processing parts, the inventory management service may increase staffing at the FSF, thereby increasing labor costs. During slow activity periods, this additional labor resource may be underutilized.

Another challenge is after-hours pick-up of ordered items. There are two specific scenarios involving after-hours pick-up. The first case is when a part is ordered before the close of business, but the technician is unable to retrieve the ordered part until after the close of business. This causes the customer to incur additional charges (for after-hours pick-up) that could be avoided if the technician could come earlier or if the technician could pick-up the parts without any FSF personnel assistance. The second case is when a part is ordered after business hours and must be picked-up before the FSF opens for business. In this case, an after hours charge is unavoidable, but it also may be very inconvenient for the technician and FSF personnel to meet in person to get the part, especially, if this happens in the middle of the night or during the weekend. Earlier attempts at resolving the described challenges involve systems and methods of delivering articles to an unattended facility for pick-up or retrieving articles left at such an unattended facility. Some of the more relevant attempts include:

U.S. Pat. No. 5,983,202, “Office-Supplies Management System,” filed Apr. 3, 1996 by Yabe et al. (assigned to Kokuyo Co., Ltd.), claiming benefit of a foreign application filed Nov. 30, 1995, which discloses an office supplies management apparatus in an office supplies area. It describes an automated apparatus for distributing office supplies unattendedly that may be incorporated into a larger office supplies room.

U.S. Pat. No. 6,404,337, “System and Method for Providing Access To An Unattended Storage,” filed Oct. 30, 2000 by Van Till et al. (assigned to Brivo Systems, Inc.), claiming benefit of a provisional application filed Oct. 28, 1999, describes delivering an item to an unattended storage facility and obtaining a digital signature as proof of delivery. It also discloses using a tracking number as an access code for the unattended storage facility.

U.S. Pat. No. 6,439,345, “Item Pick-Up System,” filed May 22, 1996 by Recktenwald et al. (assigned to Sears, Roebuck and Co.), describes a system for picking up previously purchased items by entering information into a system that identifies the customer and the purchase and the purchase is made available to the customer by an attendant. The system also allows customers to enter information about return items that are then delivered to an attendant by the customer.

U.S. Pat. No. 6,456,900, “Locker Type Merchandise Delivering System,” filed Mar. 27, 2001 by Kakuta (assigned to Fujitsu Limited), describes a system for providing “a locker type merchandise delivering system capable of safely settling the charge of merchandise and delivering merchandise for indefinite customers while protecting privacy of the customers.” (Col. 2, lines 36-40.) U.S. Pat. No. 6,480,758, “Package Delivery System,” filed May 16, 2001 by Stevens and claiming priority from a provisional application filed on May 25, 2000 discloses a system where packages are delivered to electronically controlled lockers that are located by an address comprised of coordinate information rather than a conventional street address.

United States Patent Application Publication No.: 2002/0032501, “Item Delivery and Retrieval System,” filed Mar. 27, 2001 by Tilles et al. (assigned to Northrop Grumman Corporation) and claiming priority to a provisional application filed on Jul. 26, 2000 describes a system for retrieving items following a delivery attempt and placing the items into a secure, unattended carousel from which the intended recipient can later retrieve them. Generally, the disclosure describes a storage system where items are placed in a vertical carousel system by one user, and retrieved from it by another user with the appropriate credentials. The first user may be a representative of a mail or parcel delivery service, such as the USPS, UPS, etc. The second user may be the intended recipient of the parcel. The device has four different modes of operation: (1) barcoded notification form; (2) Internet e-mail notification; (3) customer loyalty card; and (4) front counter clerk. The secure unattended facility is generally co-located with an attended postal facility.

United States Patent Application Publication No.: 2002/0177922, “Automated System for Efficient Article Storage and Self-Service Retrieval” filed May 30, 2001 by Bloom discloses a storage system for storing delivered articles, which randomly stores a delivered article destined for a recipient and allows for unattended retrieval.

Furthermore, Automatic Teller Machines (ATMs) are often used concurrently with teller windows at bank locations to reduce or eliminate the long wait time to conduct basic banking transactions.

However, none of the prior art references appear to resolve the challenge of providing parts and receiving return parts to customers in an efficient and timely manner and efficiently utilizing the resources of an inventory management service in such process.

### BRIEF SUMMARY OF THE INVENTION

The embodiments of the present invention provide systems and methods for efficiently operating an item pick up and drop off facility while providing efficient and rapid service to customers. Embodiments of the invention provide for reducing the labor hours required to attend to a customer pick-up/return window at a service parts facility. Earlier attempts at resolving distribution and returns challenges did not consider combining the traditional window transactions at a forward stocking facility with an unattended facility. Generally, the FSFs of the embodiments of the invention are multi-client facilities, meaning that they provide parts to and receive return parts from technicians that are employees or agents of more than one service organization.

Aspects of the invention include systems and methods for managing an inventory of service parts, wherein an attended facility operated by an inventory management service and having an attended service area where service parts may be distributed and returned, has an associated unattended facility capable of containing a plurality of service parts. The unattended facility has one or more secure areas, a processor and a data entry device, with each secure area having a door and a lock, wherein the processor is programmed to open one or more locks when a passcode is entered into the data entry device. An inventory management system is associated with the attended facility and the unattended facility and is capable of tracking service parts in the inventory of the attended facility, service parts that have been placed in the unattended facility, service parts that have been distributed from the attended facility and the unattended facility and service parts that have been returned to the attended facility and the unattended facility.

Example embodiments of the invention described herein disclose systems and methods to incorporate an unattended drop off and pick-up facility within a forward stocking facility (an attended facility) for the retrieval and return of service parts. The unattended facility provides convenient access for technicians to retrieve ordered parts from the unattended system or to place return parts in the system and functions concurrently with an attended window at the facility.

Generally, FSFs, as known in the art, incorporate an electronic inventory management system that includes tracking inventory items into and out of an FSF. This inventory management system may be distributed and include any number of other FSFs, DCs, UFs, customers and vendors. It will generally include information about the items in the inventory of the DCs, FSFs and UFs. Embodiments of the invention include having the inventory system of the facility electronically linked with the unattended pick-up and return system such that ordered items placed in the unattended system are tracked and monitored. Even though the embodiments of the invention described herein primarily focus on the logistics of service parts, the same ideas and concepts are equally applicable for the distribution and return of other items.

Programmable processors, data entry devices, data display devices, monitoring devices and network connections enable an unattended facility to control and monitor access to their secure areas. The control and monitoring system of the unattended facility may be integrated with the inventory management system of the FSF such that duplicitous data entry requirements are reduced. Embodiments of the present invention use unattended pick-up and return systems to reduce window staffing, or even allow the attended window to be closed during certain times, while still allowing technicians to perform pick-up or return transactions quickly. The system will increase productivity for both, FSF personnel and customers.

Other aspects of the invention include an unattended item distribution and return system that is incorporated into an inventory management service's attended facility having an attended service area. The unattended distribution and return system is comprised of an unattended facility having one or more secure areas, one or more processors, and a data entry device, with the secure areas having a lockable door, the lock on the door connected to the processor such that the processor may be programmed to open one or more locks when a passcode is entered into the data entry device. Items are placed into the unattended facility by inventory management service personnel and are held for pick-up by technicians.

One or more computer servers are connected to the processors of the unattended facility. The servers are, among other things, capable of notifying technicians that items are available for pick-up in the secure areas of the unattended facility.

An inventory management system operating on the computer server may be integrated with the unattended facility's control system. If the inventory management system has information about items that are in the inventory of the inventory management service's attended facilities or under the control of the inventory management service, then information about items placed in the secure areas of the unattended facility is not required to be redundantly entered into the data entry device of the unattended facility if the information was previously entered into the inventory management system.

A database is associated with the inventory management system, wherein the database is used to record the pick-up or placement of items in the secure areas of the unattended facility and update an item's inventory records accordingly; and one or more interface devices are associated with the inventory management system, so that the interface devices may be used to enter and view information about the items in the inventory of the inventory management service.

Another aspect of the invention is a method for the distribution and receipt of returned items by an inventory management service. An unattended facility is provided that is comprised of one or more secure enclosures at a location that is proximate to an attended facility. The unattended facility is comprised of one or more secure enclosures with each secure enclosure having a door with a lock; a data entry device; and a processor wherein the processor is configured to send a signal that locks or unlocks the lock on the door when a passcode is entered into the data entry device. The unattended facility is connected to an inventory management system via a network. The attended facility has an attended service area and the attended facility is controlled by the inventory management service.

An inventory of items is maintained in one or more storage facilities controlled by an inventory management service with the inventory management system having information about the inventory of items.

One or more items are taken from the storage facilities and placed within the secure enclosures of the unattended facility and any one of a plurality of customers are allowed to access the items, as needed and the inventory of items stored in the inventory management system is updated when the items are accessed and taken from the unattended facility.

Another aspect of the invention is a method for the distribution and receipt of returned items by an inventory management service. The method involves an unattended facility comprised of one or more secure enclosures that is provided at a location within an attended facility having an attended service area and the attended facility controlled by the inventory management service. The unattended facility is comprised of one or more secure enclosures with each secure enclosure having a door with a lock; a data entry device; and a processor wherein the processor is configured to send a signal that locks or unlocks the lock on the door when a passcode is entered into the data entry device. The unattended facility is connected to an inventory management system via a network.

An inventory of items is maintained in one or more storage facilities that are controlled by an inventory management service with the inventory management system having information about the inventory of items.

One or more items are taken from the storage facilities and placed within the secure enclosures of the unattended facility, and any one of a plurality of customers are allowed to access the items, as needed. Information about the inventory of items is updated in the inventory management system when the items are accessed and taken from the unattended facility.

Yet another aspect of the invention is a method for the return of an item to an unattended facility. This method is comprised of providing an unattended facility located proximate to an attended facility controlled by an inventory management service, the unattended facility is comprised of one or more secure enclosures with each secure enclosure having a door with a lock; a data entry device; and a processor wherein the processor is configured to send a signal that locks or unlocks the lock on the door when a passcode is entered into the data entry device.

An item is returned to the unattended facility and return information about the return item is entered into the data entry device.

The return item is associated with a return identifier, wherein the return identifier contains information about the return item.

The return item is placed in a secure enclosure of the unattended facility and the door of the secure enclosure is closed and locked.

The return information from the unattended facility is transmitted to a server via a network; and the return information is used to process the item prior to the item's retrieval from the unattended facility by personnel associated with the inventory management service.

Another aspect of the invention is a method of managing the labor resources of an inventory management service's attended facility. This method is comprised of providing an unattended distribution facility proximate to the attended facility such that an item ordered by a technician may be placed in the unattended distribution facility prior to the technician's arrival at the attended facility by inventory management service personnel and the technician may retrieve the ordered item without the assistance of the inventory management service's personnel.

An unattended returns facility is provided proximate to the attended facility such that the technician may return items without having to place the items with the inventory management service personnel; and technicians are provided access to the unattended distribution facility and the unattended returns facility at times when inventory management service personnel are not available in the attended facility.

Yet another aspect of the invention is a method of utilizing an unattended distribution and return system by an inventory management service. This method comprises incorporating an unattended item distribution system into an attended facility controlled by the inventory management service; incorporating an unattended item returns system into the attended facility controlled by the inventory management service; providing access for a customer to retrieve an ordered item from the unattended item distribution system; providing access for the customer to place a return item in the unattended item returns system; operating an attended item distribution area and an attended item returns area at the attended facility concurrently with the unattended item distribution system and the unattended item returns system during certain time periods, wherein certain customers may retrieve the ordered item at the attended item distribution area or return the return item at the attended item returns area; operating the unattended item distribution system and the unattended item returns system during certain time periods when the attended item distribution area and an attended item returns area at the attended facility are not available, wherein certain customers may retrieve the ordered item at the unattended item distribution system or return the return item at the unattended item returns system; and

electronically linking an inventory management system with a control system associated with the unattended item distribution system so that ordered items taken from an inventory of items in the attended facility may be tracked when the ordered items are placed in the unattended item distribution system and when they are removed from the unattended pick-up and return system.

Another aspect of the invention is a method of utilizing an inventory management system to track items that have been provided to technicians by an inventory management service. This method comprises identifying items with a unique item identifier; entering the item identifier into the inventory management system along with a location of the item; updating the location of the item in the inventory management system as necessary if the item is re-located; distributing the item to a technician; recording a distribution date that the item was distributed to the technician and an identifier associated with the technician in the inventory management system; monitoring the time from the distribution date that the item is kept by the technician with the inventory management system; and

notifying the technician for the item if the item is not returned to the inventory management service within a certain amount of time from the distribution date.

These and other aspects of the invention are discussed in more detail herein.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1A is a pictorial view of an exemplary commercially available unattended facility with lockers that may be used in embodiments of the invention;

FIG. 1B is a pictorial view of a locker in an exemplary commercially available unattended facility that may be used in embodiments of the invention;

FIG. 1C is a side view of the exemplary commercially available unattended facility with lockers of FIG. 1A with portions broken away to show interior detail that may be used in embodiments of the invention;

FIG. 2 is a flowchart of prior art methods of providing ordered items to a technician by an inventory management service;

FIG. 3 is a flowchart of prior art methods of a technician retrieving ordered items from an inventory management service;

FIG. 4 is a flowchart of methods of providing ordered items to a technician by an inventory management service in an embodiment of the invention;

FIG. 5 is a flowchart of methods of a technician retrieving ordered items from an inventory management service in an embodiment of the invention;

FIG. 6A is a diagrammatic plan-view illustration of an exemplary inventory management service facility with an incorporated unattended facility for an embodiment of the invention;

FIG. 6B is a diagrammatic profile-view illustration of a portion of an exemplary inventory management service facility with an incorporated unattended facility for an embodiment of the invention;

FIG. 6C is a diagrammatic plan-view illustration of an exemplary inventory management service facility with an incorporated unattended facility for an alternative embodiment of the invention;

FIG. 7 is an exemplary diagrammatic representation of various network connections within and between inventory management service facilities and other parties for an inventory management system in embodiments of the invention; and

FIG. 8 is a graphical representation of the movement of items and information when transferring items associated with an order identifier from a shipper to an inventory management service facility in an embodiment of the invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the present invention may be described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Inventory management services (IMSs) are generally engaged on a contractual basis to supply customers with parts. Generally, these customers are service organizations such as, for example, computer repair companies, copier and office machine repair companies, etc. These customers usually employ technicians who interface with the IMS to obtain parts to repair devices. In some instances, the technician may place the order with the IMS, whereas in other instances the customer (the technician's employer) will place the order for the technician. Parts may be ordered based on what the technician knows is wrong with the device to be repaired, or based on what the technician suspects may be wrong with the malfunctioning device (a preliminary diagnosis). If the technician is unsure of the cause of the problem, the technician may order more parts than will actually be necessary to repair the device. When parts are provided to a technician, information about such parts is placed in a “loan file” that is associated with that technician and the technician's employer. This information may be placed in the “loan file” manually or automatically as a function of an inventory management system. If the parts are not used by the technician and are returned undamaged within a certain time period from the time they were taken, then the information about the returned part will be removed from the “loan file”; otherwise, the technician or the technician's employer will be responsible for the cost of the parts that remain in the loan file beyond the designated time period.

It is generally the technician's responsibility to make arrangements to pick up or return parts to the IMS. Generally, the technician will receive one or more work orders at the beginning of the technician's work shift. The technician will review the work orders and place orders for parts with the IMS and receive one or more order numbers for these parts. Such orders may be placed directly with the IMS, or they may first be placed with the technician's employer who then contacts the IMS in some manner (e.g., Electronic Data Interchange (EDI), telephone, email, Internet, etc.) and places the orders. Or, in some instances, the technician's employer may have already ordered the parts when the technician receives the work orders. Generally, the technician's will go to an IMS-controlled facility such as a FSF or UF to retrieve the ordered parts and possibly to return parts. Because IMSs may provide parts to any number of customers and because shift changes for customers may occur at the same times or nearly the same time, long lines of technicians may form at IMS facilities on a cyclical basis corresponding to the shift-change times of the technicians. The wait caused by these long lines may decrease the efficiency and productivity of the technicians.

To avoid the “long line” challenge, some technicians or customers may make arrangements to have the desired parts delivered to the technicians. However, this delivery feature adds cost to the service provided by the IMS and, in some instances, the courier may experience difficulty in locating the technician. Therefore, the inventive concepts disclosed in the embodiments of the present invention were developed in order to provide means for technicians to retrieve and/or return parts in an expedient manner, for IMSs to efficiently, accurately and expediently provide parts to technicians and receive return parts from technicians, while overcoming the challenges not resolved by the prior art.

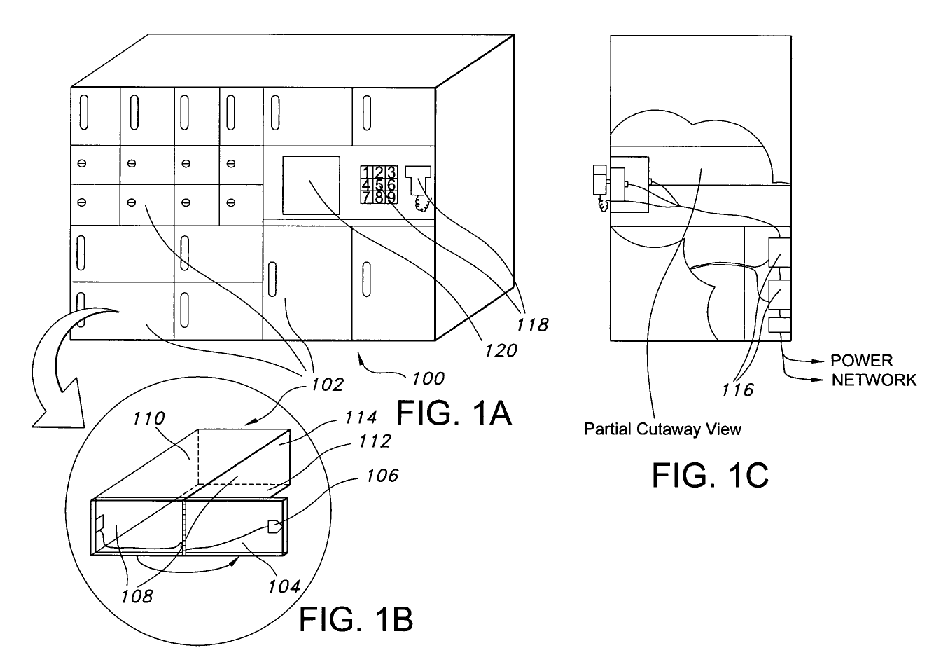

The broad concept of the embodiments of the invention is to place an unattended facility within or proximate to an attended IMS-controlled facility such as, for example, a FSF. The hardware that comprises unattended facilities is generally commercially-available products such as those manufactured and distributed by, for example, SALock, Inc./TEKWave, Inc. of Duluth, Ga., SupplyPro, Inc. of San Diego, Calif., or American Locker Security Systems, Inc. of Jamestown, N.Y., among others. The products may also be patented. Some of the embodiments of the invention described herein may utilize unattended facilities covered by one or more United States patents, including U.S. Pat. No. 6,300,873 issued on Oct. 9, 2001 to Kucharczyk, et al.; U.S. Pat. No. 5,774,053 issued on Jun. 20, 1998 to Porter; and U.S. Pat. No. 5,979,750 issued on Nov. 9, 1999 to Kindell, each completely incorporated herein and made a part hereof. FIGS. 1A, 1B and 1C illustrate a typical commercially available unattended facility that may be used in embodiments of the present invention.

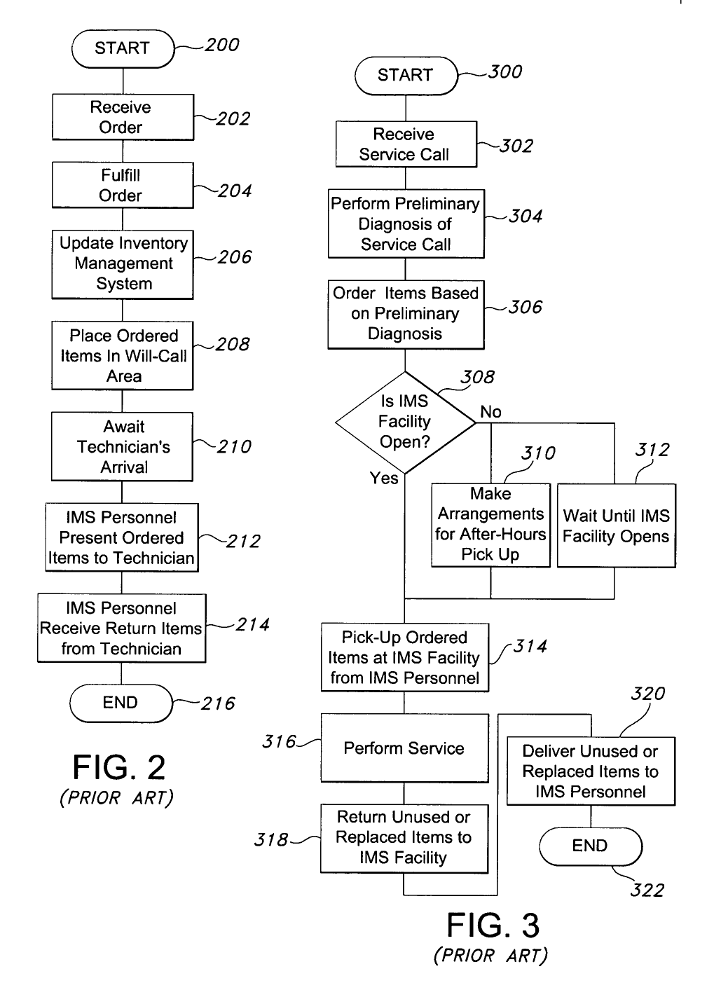

FIGS. 1A, 1B and 1C illustrate an embodiment of an exemplary commercially available unattended facility 100. FIG. 1A is a pictorial view of an exemplary commercially available unattended facility with lockers that may be used in an embodiment of the invention. FIG. 1B is a pictorial view of a locker in an exemplary commercially-available unattended facility that may be used in an embodiment of the invention and FIG. 1C is a side view of the exemplary commercially-available unattended facility with lockers of FIG. 2A, with portions broken away to show interior detail as they may be used in an embodiment of the invention.

The unattended facility 100 is generally comprised of one or more secure enclosures such as lockers 102 of various sizes. Each locker 102 has a door 104 with a lock 106, sides 108, top 110, bottom 112 and a back 114. In another embodiment (not shown), the locker 102 may not have a back 114 to facilitate placing items in the locker 102 from a restricted area. In other embodiments (not shown), the locker 102 may have ventilation means such as holes or holes with forced ventilation such as, for example, a fan. In yet other embodiments, the lockers 102 may be heated or cooled depending upon the requirements of items that are placed within.

Generally, an unattended facility 100 has a control system that includes one or more processors 116, a data entry device 118 and any necessary wiring or communications medium. In some embodiments the control system may include a display device 120. The processors 116 are associated with the unattended facility 100 and control each lock 106. The processors 116 are programmed to unlock specific lockers 102 when certain identifying and authorizing information (i.e., a passcode such as, for example, a PIN, order number, name, badge number, etc.) is entered into or read by the data entry device 118. The data entry device 118 may be, for example, a keypad, a barcode scanner, an infrared scanner, a radio frequency identification (RFID) reader, a voice recognition device, a touch screen, a personal computer, a wireless device, etc. Some embodiments of the unattended facility 100 may have a display device such as, for example, a display screen 120. The display device 120 may be incorporated into the unattended facility 100 or it may be located close by such as, for example, in close proximity to the data entry device 118. In one embodiment, the processors 116 may be programmed locally through the data entry device 118 to allow access to one or more lockers 102 when the correct identifying information is entered. In embodiments of the invention, the unattended facility 100 may be connected to a central server and/or the inventory management system of the inventory management service controlled facility via a network. Therefore, in other embodiments of the unattended facility 100, the processors 116 may be programmed for access to lockers 102 by information sent from the inventory management system of the central server via the network.

However, in other embodiments of the invention, the unattended facility may not be a commercially available product, but may be, for example, a secure area that is built into a wall with a lockable door on one side and a means for placing ordered parts into the secure area on the other. For instance, the back may be open with the area in the back secure from unauthorized access or the back may have a door that may, or may not be lockable. The door that is accessible by a technician has an electronic lock that is controlled by one or more processors that are associated with the secure areas by a passcode entered into a data entry device that is also associated with the secure areas, in the manner described for the commercially-available products, above.

Generally, a technician's ordered parts will be placed into one or more secure areas with the processor that controls the electronic locks that secure the doors to these areas programmed to open the locks upon the entry of a proper passcode. In some instances, the passcode may be, for example, a technician's employee number or an assigned personal identification number (PIN), or it may be the order number, a portion of the order number, or a combination of the order number. In other instances, the processor may respond to a passcode that is transmitted magnetically, by radio frequency, by infrared, optically, by electronic transmission, by sound or any other means to a data entry device that is capable of receiving the passcode and passing it to the processor where it is associated with one or more secure areas thereby allowing access to such areas.

Pick-Up Process

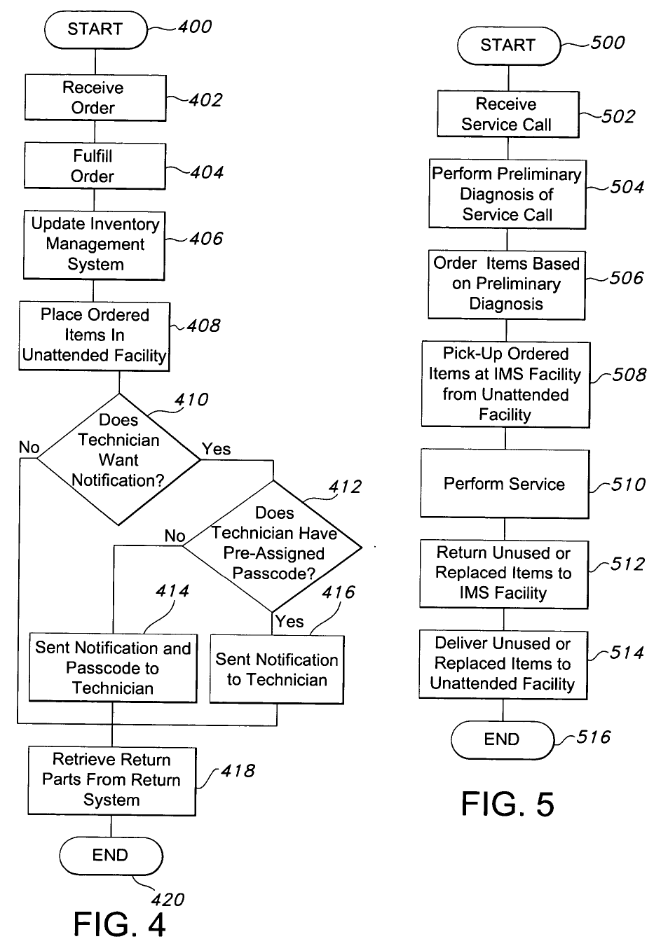

Prior art methods of an inventory management service providing an ordered item to a technician and of a technician retrieving the ordered parts from an inventory management service are illustrated in the flowcharts of FIGS. 2 and 3, respectively.

The prior art method of providing an ordered item to a technician begins in Step 200 of the flowchart of FIG. 2. In Step 202 an order for items is received by an inventory management service. As previously described, this order may come from a number of sources including technician, a technician's employer, a person desiring service, etc. It may be transmitted to the IMS in a variety of ways including telephone, EDI, Internet, email, facsimile, etc. In Step 204, the order is fulfilled by the IMS. The ordered items may be obtained from inventory on-hand in the IMS-controlled facility where the order is to be picked up, from another IMS-controlled facility (DC, FSF, etc.), or from one or more third-party vendors. If one or more of the ordered items are taken from inventory of an IMS-controlled facility, in Step 206 the inventory management system of the facility is updated. In some embodiments of the invention, the IMS-controlled facilities utilize the same or an interconnected inventory management system. In some instances, the IMS may not have one or more of the ordered items in the inventory of its facilities. In such cases, the IMS may contact a third-party vendor to provide the ordered items. If time permits, the items will be shipped from a third-party vendor to the IMS-controlled facility, entered into the inventory of the IMS-controlled facility (and its inventory management system), and then “ordered out” of the inventory management system to await pick-up by a technician. If there is not sufficient time, the items may arrive at the receiving area of the IMS-controlled facility and immediately be made available for pick-up by the technician without ever entering the inventory of the IMS-controlled facility (a process generally known as “cross-docking”).

In some instances, a customer may order an item that is not in the inventory of the FSF. Such an order may be forwarded to a DC for fulfillment. Because of the larger inventory of items carried in a DC and because they are generally located in close proximity to the shipping facilities of overnight parcel delivery services such as, for example, the facilities of UPS of Atlanta, Ga., these orders may be transferred to a DC relatively late in the evening (i.e., 11:00 p.m., for example), fulfilled, and shipped to an FSF, arriving relatively early in the morning (i.e., 9:30 a.m., for example) so that the order may be cross-docked and made available for pick-up that morning that it arrives at the FSF.

In step 208, the order items are placed in a will call area. Here, they are held to await the arrival of a technician for pick up (Step 210). When the technician arrives at the IMS-controlled facility, IMS personnel will take the ordered items from the will call area and physically hand-off the ordered items to the technician (Step 212). In many instances, the technician will be asked to sign for the items they have received, with the technician's signature serving as proof of pick-up. Also, the technician may be returning items that the technician previously ordered but were not used, ordered items that have been discovered damaged, or returning used, damaged, or replaced items such as under a warranty replacement program. If returning items, in Step 214 the technician surrenders physical possession of the items being returned to IMS personnel. The method is thus complete at Step 216.

Step 300 of FIG. 3 begins the prior art method of a technician receiving ordered items from an IMS. In Step 302, the technician or the technician's employer receives a request for service or repair. In Step 304, a preliminary diagnosis of the service or repair request is performed and items or parts that may be used in the service or repair are identified. In Step 306, the parts or items identified in Step 304 are ordered from the IMS. In Step 308, the technician is required to determine whether the IMS-controlled facility will be open at the time of pick-up. If it will not be open, then in Step 310 the technician may make extraordinary arrangements with the IMS for after-hours pick up of the ordered items. Usually such extraordinary arrangements result in an additional expense to the customer. If after-hours pick up (Step 310) is not arranged, then in Step 312 the technician is resigned to await the opening of the IMS-controlled facility. In Step 314, the technician picks up the ordered items from IMS personnel at an IMS-controlled facility. Referring back to Step 308, if the IMS-controlled facility will be open at the planned time of pick up, then (proceeding to Step 314), the ordered items are picked up from IMS personnel at an IMS-controlled facility. In Step 316, the technician performs the requested service (Step 302), using whatever ordered items are needed. In Step 318, the technician transports any unused items or items that may have been delivered in a damaged state or items being returned for some purpose to the IMS-controlled facility (once again, this must occur when the facility is open). In Step 320, the technician delivers the returned items (as described in the previous Step) to IMS-personnel at the IMS-controlled facility. The method of receiving the ordered items ends with Step 322.

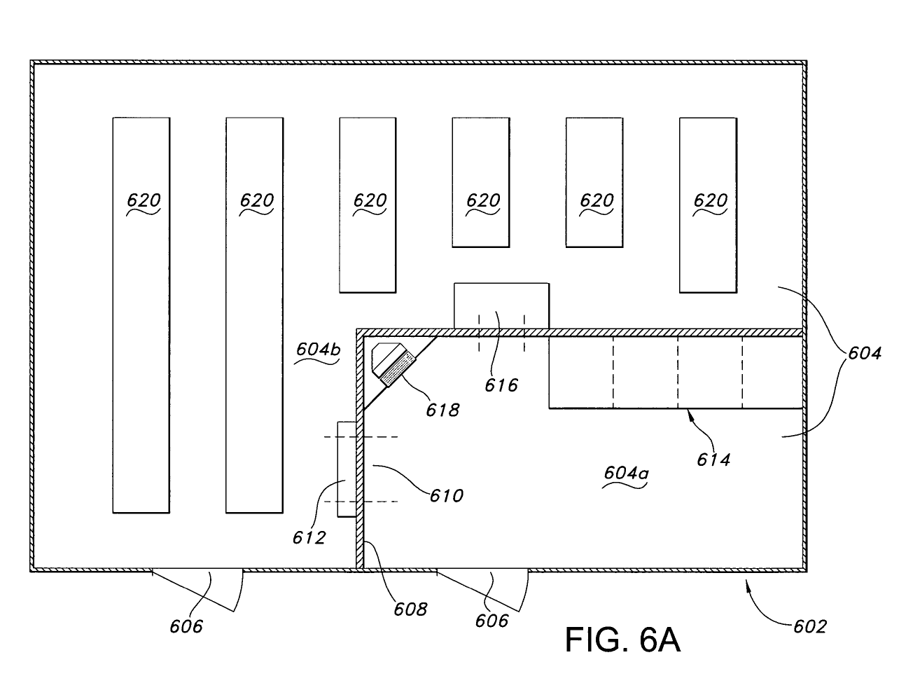

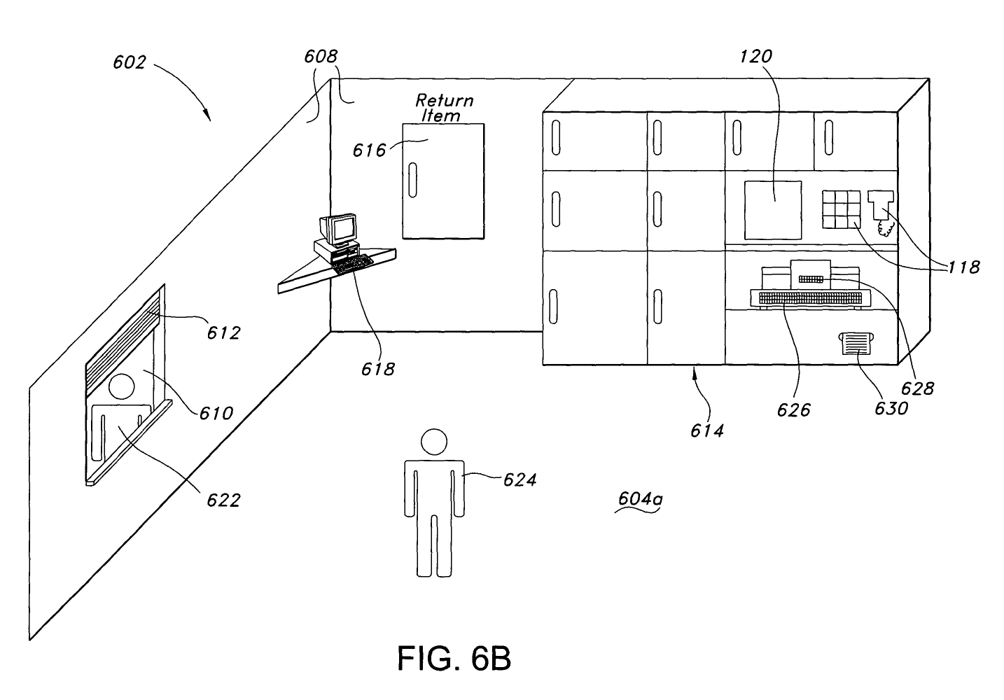

Prior art FIGS. 2 and 3 are to be compared with FIGS. 4 and 5, which are flowcharts of methods of providing ordered items to a technician by an inventory management service and of a technician retrieving ordered items from an inventory management service in embodiments of the invention, respectively.

The method of FIG. 4 begins with Step 400. In Step 402 the IMS receives an order from a technician or a technician's employer, as described for FIG. 2, above. In Steps 404 and 406, also as described in the discussion of FIG. 2, above, the order is fulfilled and the inventory management system of the IMS is updated, respectively. In contrast to the steps of FIG. 2, in Step 408 of FIG. 4 the ordered items are placed in one or more secure areas of an unattended facility. The processor of the unattended facility is programmed to open the electronic locks securing the doors of the secure areas once a unique passcode has been entered into a data entry device at the unattended facility. This passcode may be one that is assigned to a technician or it may be a passcode that is generated just for this order. Step 410 determines whether the technician has requested notification that the order has been fulfilled and is ready for pick up. If the technician has requested notification, then in Step 412 it is determined whether the technician has a pre-assigned passcode. If the technician does have a pre-assigned passcode, then in Step 414 the technician is notified that the order is ready for pick up. This notification may be in the form of an electronic transmission such as a page, telephone call, email, facsimile, etc., or by any other means of notifying the technician of the availability of the ordered items. In Step 412, if the technician does not have a pre-assigned passcode, then a passcode will be included in the notification to the technician (Step 416). The technician will be able to use this provided passcode to access the secure area(s) in the unattended facility that contain the ordered items. Because in some embodiments of the present invention, access to the unattended facility is provided on a 24-hour basis, seven days a week, there is no requirement for IMS-personnel to be present when the technician retrieves the ordered items from the unattended facility. In Step 418, IMS-personnel may retrieve any return items that have been placed in the returns system by technicians. Because of the unattended nature of the returns system, this activity may generally occur at the convenience of the IMS personnel. In many instances, return items will be gathered at a certain time or certain times throughout the workday. Therefore, return items may be “batch-processed” in a way that is generally more efficient than retrieving each individual return item separately. Therefore, this embodiment of a method to provide ordered items to a technician ends at Step 420.

FIG. 5 is a flowchart of an embodiment of a method for a technician to retrieve ordered items from an inventory management service. It is to be compared with the prior art FIG. 3, previously described. The method of this embodiment begins with Step 500. Steps 502, 504 and 506 are identical to Steps 302, 304 and 306 of FIG. 3 that have previously been described. In Step 508, the technician proceeds to the IMS-controlled facility and is able to access the unattended facility with 24-hour, seven day a week availability at the technician's convenience. The technician's unique passcode, as entered into a data entry device associated with the unattended facility, provides access to one or more secure areas of the unattended facility that contain the technician's order. The processor of the unattended facility has a programmed association between an entered passcode and the secure area containing the ordered items related to that passcode. IMS personnel performed this programming when the ordered items were placed in the secure areas of the unattended facility.

The technician obtains the ordered items from the unattended facility and in Step 510 uses them to perform the repair or service, as was requested. In Step 512, if any of the ordered items are unused after the technician has performed the service, if any of the ordered items were damaged when inspected, or if the technician desires to return items that were replaced during the service, then such items are brought to the IMS-controlled facility. In Step 514, the technician utilizes the unattended facility for the return of the items and places the return items in one or more secure areas of the unattended facility thereby avoiding having to inconveniently await the opening of the IMS-controlled facility. The use of an unattended facility for the return of items is fully discussed in U.S. patent application Ser. No. 10/285,115, filed on Oct. 31, 2002, by Knowles et al., and U.S. patent application Ser. No. 10/401,915, filed Mar. 28, 2003 by Bong et al., both assigned to UPS (f/k/a United Parcel Service of America, Inc.), and both of which are completely incorporated herein in their entirety by reference and made parts hereof. The method of the embodiment illustrated in FIG. 5 ends at Step 516.

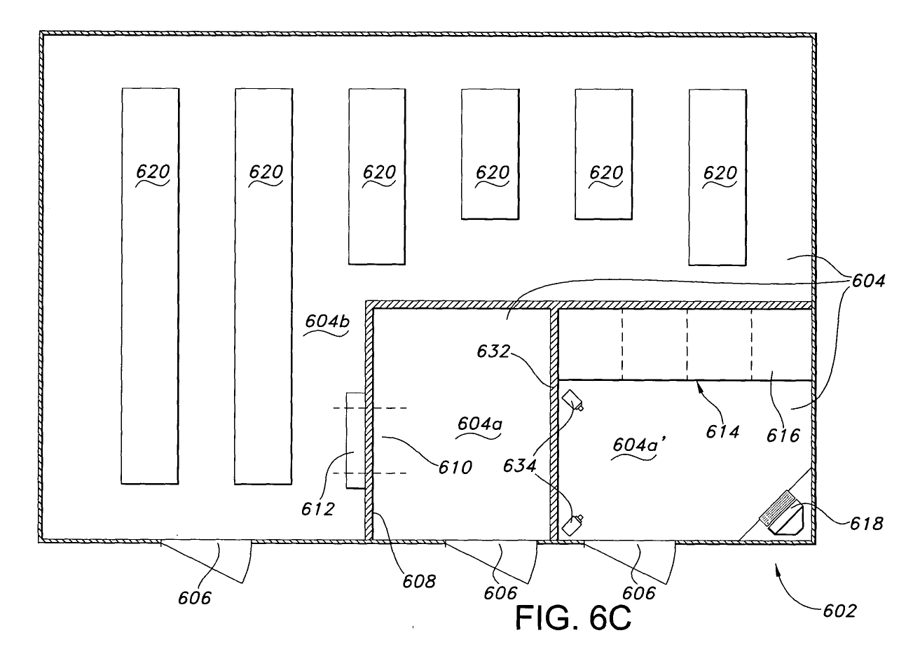

FIGS. 6A, 6B and 6C are diagrammatic representations of an unattended facility incorporated into an IMS-controlled facility in various embodiments of the invention. The IMS-controlled facility 602 may be, for example, a building, room or otherwise secure area 604 with one or more lockable entry doors 606. One portion of the area 604 is provided for customer service 604a, whereas another portion 604b of the area 604 is used for storing inventory items and as a working area for IMS personnel. The facility is provided with a wall, fence or other means 608 of separating the customer service area 604a from the inventory storage and working area 604b. A service area 610 such as a window, door, etc. is provided in the separator 608 so that items may be passed to and from the customer service area 604a and the working/storage area 604b. Generally, this service area 610 is securable with a security device 612 such as by using a lockable screen, door, fence, etc., so that the customer service area 604a may be secured from the storage/working area 604b at times when the service area 610 is not open or when IMS personnel 622 are not present.

In one embodiment, an unattended facility 614 will be located in the customer service area 604a of the IMS-controlled facility 602. This allows the working/storage area 604b to be closed and locked by closing the service area 610 and securing it with the security device 612 so that technicians or other customers 624 may access the customer service area 604a and the unattended facility 614 without having access to the working/storage area 604b. The returns area 616 may be incorporated into the unattended facility 614 whereby the technician 624 places the return items into one of the secure areas of the unattended facility 614, or in other embodiments it may be incorporated into the IMS-controlled facility 602, such as, for example, secure areas built into the walls of the facility 602, as is illustrated in the embodiment of FIGS. 6A and 6B. In one embodiment, the secure areas 102 of the unattended facility 616 may have doors or other means of accessing the secure areas 102 from the rear so that IMS personnel 622 may place items into or retrieve items from the secure areas 102 from the working/storage area 604b and without having to enter the customer service area 604a.

The embodiments illustrated in FIGS. 6A, 6B and 6C have a data entry and display device (data device) 618 that may be used by IMS personnel 622 to program the processor of the unattended facility 614 when placing ordered items in the unattended facility 614 for pick-up by a technician 624. A technician 624 may also use the data device 618 to enter a passcode or some other unique identifier in order to gain access to the secure areas of the unattended facility 614 that contain the technician's 624 ordered items. In an embodiment of the invention where the control system of the unattended facility 614 is integrated into the inventory management system of the IMS-controlled facility 602, the data device 618 may be used by IMS personnel 622 and technicians 624 to check inventory status and the status of ordered items. In other embodiments, the unattended facility 614 may also be equipped with one or more data entry devices 118 and/or displays 120 that may be used to enter programming instructions or to access the secure areas of the unattended facility 614 and the returns area 616.

In one embodiment, the data device 618 may be equipped with a print device 626 so that a technician 624 may create a return shipping label 628 or other printed material, such as, for example, an intelligent authorization for return shipping (LARS) label used by UPS and described in U.S. patent application Ser. No. 10/123,066, filed Apr. 11, 2002 by William L. Smith, assigned to UPS (fk/a United Parcel Service of America, Inc.), completely incorporated herein in its entirety by reference and made a part hereof. The print device 626 may be stand alone (not shown), or it may be integrated into the unattended facility 614 (as shown in FIG. 6B). In an embodiment of the invention, the technician 624 may associate the return-shipping label 628 with a return item before placing the return item in the returns area 616. In one embodiment, when returning items to the unattended facility 614 or the returns area 616, the technician receives a printed receipt 630 as proof of returning the items. Also shown in FIGS. 6A and 6C are optional storage shelves 620 for storing inventory in the IMS-controlled facility 602.

FIG. 6C illustrates an alternative embodiment of the IMS-controlled facility 602. In this embodiment, the customer service area is divided into two sections 604a, 604a′ by a divider 632. A first section of the customer service area 604a is available during normal business hours to transact business with IMS personnel 622. This section 604a may be closed when IMS personnel 622 are not present or when they may be unavailable to assist customers 624. It may be closed by shutting the security device 612 to the service area 610 or by locking the door 606 leading to this area. An unattended area 604a′ is provided in this embodiment for technicians 624 to retrieve ordered items from the unattended facility 614 or to return items. This unattended area 604a′ has an alternate means of entry 606 that may allow technicians 624 access at any time or during hours when the service area 610 is unavailable.

The particular embodiment illustrated in FIG. 6C includes a data device 618 separate from those of the unattended facility 614. As in the embodiments of FIGS. 6A and 6B, this data device 618 may work concurrently with the data entry devices 118 of the unattended facility 614, or it may replace the unattended facility's 614 data entry devices 118. The returns system 616 of the embodiment of FIG. 6C is incorporated into the unattended facility 614, although it could exist separately as illustrated in the embodiments of FIGS. 6A and 6B. Another embodiment of FIG. 6C includes a locking device (not shown) to the access door 606 to the unattended area 604a′. This locking device may provide access to the unattended area 604a′ to those with the proper key, PIN, passcode, magnetic, electrical, infrared or optical signal, biometric data, etc. Technicians 624 may be supplied with the proper authorization to enter the unattended area 604a′. Limiting access in this manner may help reduce the likelihood of vandalism to the unattended area 604a′. Yet other embodiments (not shown) of the arrangement illustrated in FIG. 6C include a returns area 616 located so that it is accessible from the unattended area 604a′, but separate from the unattended facility 614.

Other embodiments of the IMS-controlled facilities 602 shown in FIGS. 6A, 6B and 6C include one or more video cameras 634 (as shown only in FIG. 6C, but may be included in other embodiments). These video cameras 634 may be incorporated into the unattended facility 614 or be positioned at angles where they record the transaction being conducted by technicians 624. The cameras 634 may be controlled such that they do not record at all times, but only record when someone enters the service area 604a, or begins a transaction with the data device 618 or the unattended facility's 614 data entry devices 118. Information stored about the transaction (discussed in more detail herein), may include information about the technician 624 that accessed the unattended facility 614 (e.g., the technician's passcode), information about the items retrieved (e.g., order number), and video data of the transaction as recorded by the video cameras 634.

FIGS. 6A, 6B and 6C are intended to represent the flexibility and ability to provide many different embodiments of the IMS-controlled facility 602 where an unattended facility 614 is utilized concurrently with a staffed service area 610. These figures are meant in no means to represent all the embodiments of the invention nor are they intended to present any limitations to the arrangement of an IMS-controlled facility 602 incorporating an unattended facility 614.

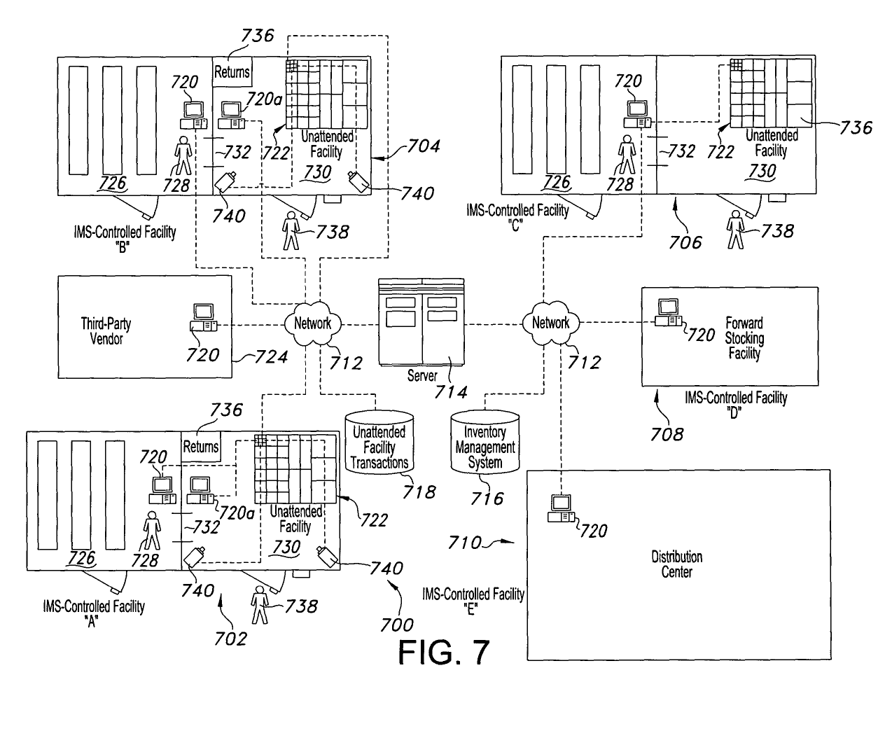

FIG. 7 is an exemplary diagrammatic representation of various network connections within and between IMS-controlled facilities and other parties for an inventory management system in embodiments of the invention. Generally, IMS-controlled facilities 702, 704, 706, 708, 710 are interconnected by one or more networks 712. The networks 712 are generally connected to one or more servers 714 on which inventory management system software is running. These servers 714 may be located at one location or distributed at a number of locations and may be associated with one or more databases 716, 718. These networks 712 may also extend in facilities that are not controlled by an IMS including, for example, a third-part vendor's facility 724 or a customer's facility (not shown). In the embodiment of FIG. 7, an inventory management system database 716 stores information about items in inventory and their whereabouts and ordered items. An unattended facilities transactions database 718 stores information about items that have been placed in unattended facilities for pickup, records information about pick ups and returns involving unattended facilities (for instance, item identifier, time stamp, passcode and video recording of an item picked up by a technician). Although shown in FIG. 7 as two separate databases 716, 718, these databases may actually be a part of a larger database or may be formed of many separate databases. Interfacing with the servers 714 is accomplished through the use of one or more interface devices 720, 720a such as, for example, personal computers, that may be operating all, some elements or none of the inventory management system software. The interface devices 720, 720a may be located at IMS-controlled facilities 702, 704, 706, 708, 710, customer facilities and vendor facilities 724. The control system of a co-located unattended facility 722, if integrated into the inventory management system 700 of the IMS-controlled facility 702, 704, 706, 708, 710 where it is located, may also serve as an interface device. The network 712 may be one or more of, or a combination of wired, wireless, or optical and may utilize in whole or in part, the Internet. This system of networks 712, servers 714, interface devices 720, 720a, software and databases 716, 718 forms an inventory management system 700 of an embodiment of the invention.

The inventory management system software tracks and reports inventory items that are under the control of the IMS, inventory items that are on order, items that have been taken from inventory by the technicians (i.e., the “loan file”), items for which payment is due from the customer, return items, the disposition of return items, and the location of items awaiting pick-up by technicians, whether they are in an attended facility or an unattended facility, among numerous other inventory-related activities.

In one embodiment, (reference “IMS-Controlled Facility ‘A’” 702 of FIG. 7), the inventory management system 700 of the IMS-controlled facility 702 is integrated with the control system of the co-located unattended facility 722 in order to present a cost effective solution for the process of staging items into the unattended facility 722. Integration allows an item or a group of items to be associated with an order identifier in the software of the inventory management system 700. The order identifier may be associated with a passcode, also in the inventory management system's software. The item or items that comprise the order are then obtained and taken to the unattended facility 722. The order identifier may be scanned or otherwise entered into the data entry device 118 of the unattended facility 722 and the items placed in one or more secure areas of the unattended facility 722. Integration of the unattended facility's control system with the inventory management system 700 allows inventory records about the ordered items to be updated to reflect the placement of the items in the unattended facility 722, when they were placed in the unattended facility 722, the association of the items with an order identifier, the association of the order identifier with one or more secure areas of the unattended facility 722, the association of the order identifier to a passcode, and when the passcode was entered into the data entry device to retrieve the ordered items, among other information items.

Without integrating the inventory management system and the unattended facility's 722 control system, staging items into the unattended facility 722 requires redundant entry of data into the IMS-controlled facility's 702 inventory management system 700 and the unattended facility's 722 control system. If no integration exists between the inventory management system 700 and the unattended facility's 722 control system, then when items are taken from inventory, a record should be made that the items have been removed from inventory in the inventory management system software and placed in an unattended facility 722 for pick up. When the items are placed in the unattended facility, then they must be associated either by order identifier or inventory identifier with a secure area within the unattended facility and a passcode that is used by the technician retrieving the items to gain access to the unattended facility 722. This association occurs by entering information into the control system of the unattended facility 722. At the very least, a technician's PIN or passcode (who retrieves the part) and an order identifier are required to be known by the unattended facility 722 for staging purposes such that when such PIN or passcode are entered into one or more of the data entry devices 118 of the unattended facility 722 the technician can be matched with the appropriate order. If additional data is required at the locker system, such as part number, quantity, etc., the redundant data entry becomes more burdensome.

Because information about items in the inventory of the IMS is already available in the inventory management system 700 of the IMS-controlled facility 702, integration between the inventory management system 700 and the unattended facility's 722 control system will remove or reduce the need for redundant data entry. This integration allows fewer steps when staging items into the unattended facility 722, while making order detail information available at interfaces to the inventory management system 700. For example, instead of entering multiple fields of information into the control system of the unattended facility 722, IMS personnel can just use a unique order identifier that is linked to all information about the ordered items residing in the IMS's inventory management system's database 716.

The integration between the IMS's inventory management system 700 and the unattended facility's 722 control system may be carried out in various embodiments. In one embodiment, the unattended facility's 722 control system is fully incorporated into the inventory management system 700. In this embodiment, IMS personnel select and assign a secure area in an unattended facility 722 for items placed in the unattended facility 722. They program the control system of the unattended facility 722 secure area for access to the secure area by a technician, all from an interface device 720 to the inventory management system 700 that may be located remotely from the unattended facility 722 so that there is no need to enter any information into the data entry devices 118 of the unattended facility 722. In this embodiment, any transactions, events or data involving the unattended facility 722 are transferred to the inventory management system 700 from the control system of the unattended facility 722 and stored in a database, such as, for example, the unattended facility transactions database 718. These events may include the technician entering a passcode in the data entry devices 118 of an unattended facility 722 to access the secure areas, opening and closing of the doors to the secure area, time stamping of the transaction, an identifier of the secure area accessed, an identifier of the unattended facility accessed, identifiers associated with the order or items retrieved, a PIN or other unique identifier associated with the technician retrieving the items, video data of the transaction, etc. The order identifier or item identifier may be cross-referenced with the inventory management system database 716 so that a complete history of the item is available, including when it was entered into inventory, where it came from (vendor), cost, time in inventory, where it was held in inventory, when it was taken from inventory, technician who received the item, etc.

In another embodiment, the level of integration between the inventory management system 700 and the control system of the unattended facility 722 may be such that only certain milestones such as, for example, what the ordered items are and when the ordered items were pulled from inventory is captured from the inventory management system 700, when the order items are ready for pick-up and when they are actually picked up and by whom is captured from the unattended facility's 722 control system. This information will be stored in the inventory management system's 700 databases 716, 718. Embodiments of the invention include integrating the inventory management system 700 and the unattended facilities' 722 control systems whereby a customer (technician) 738 may have the ability to view order detail information at an interface device 720 associated with an unattended facility 722, including interface devices 720 comprised of the display device 120 and data entry devices 118 incorporated into some embodiments of an unattended facility 722, and the ability to print order detail information utilizing the print device 626 when the items that comprised the order are picked up.

FIG. 7 illustrates several embodiments of inventory management system 700 connections with and between IMS-controlled facilities 702, 704, 706, 708, 710 and facilities not controlled by an IMS. Also illustrated are several embodiments of IMS-controlled facilities wherein an unattended facility 722 is co-located with an attended service area and the network connections of such facilities. For instance, IMS-Controlled Facility “A” 702 is comprised of a working/storage area 726 for IMS personnel 728, a customer service area 730 that includes an attended service area 732 and an unattended facility 722. In the particular arrangement of IMS-Controlled Facility “A” 702, the returns area 736 is located separate from the unattended facility 722, but accessible from the customer service area 730. Also, in this arrangement, there is an interface device 720 located in the customer/storage area 726 for use by the IMS-personnel 728, and an interface device 720a in the customer service area 730 that may be used by technicians 738 when retrieving and/or returning items. The unattended facility's 722 data entry device 118 and display 120, if so equipped, may also be used as an interface device 720. This particular arrangement also includes one or more video cameras 740 that may be used to record transactions involving the unattended facility 722 and returns system 736. In this instance, all the network connections 712 within the IMS-controlled facility 702 are shown routed through the unattended facility 722, although this means of network connection is not required to practice the invention.

IMS-Controlled Facility “B” 704, is similar in arrangement to IMS-Controlled Facility “A” 702 of FIG. 7. However, the interface devices 720, 720a in IMS-Controlled Facility “B” are connected directly to the network 712 without first connecting to the co-located unattended facility 722. The inventory management system 700 and the control system of the unattended facility 722 may still be integrated as information may pass back and forth through the network between the interface devices 720, 720a and the control system of the unattended facility 722.

IMS-Controlled Facility “C” has an interface device in the work/storage area 726 for use by IMS personnel 728. Technicians may use the data entry device 118 and display device 120 of the unattended facility to transact with the unattended facility 722. Furthermore, the arrangement of IMS-Controlled Facility “C” incorporates the returns area 736 into the unattended facility 722.

The attended FSF 708, without an unattended facility 722, shown as IMS-Controlled Facility “D” in FIG. 7, is a smaller warehouse-type facility that is generally located closer to the locations needed by customers. The embodiment illustrated in FIG. 7 has an interface device 720 for entering information into and receiving information from the inventory management system 700 by IMS personnel and does not include an unattended facility 722. The FSF 708 generally is attended during a set number of hours and technicians 738 obtain items from IMS-personnel 728 and return items to IMS personnel 728 at the FSF 708. Inventory items may arrive at the FSF 708 from other IMS-controlled facilities 702, 704, 706, 710, or from vendors 724, or be returned by technicians 738. Likewise, inventory items may be transferred from the FSF 708 to other IMS-controlled facilities 702, 704, 706, 710, unattended facilities 722, technicians 738, returned to vendors 724, or sent to other parties (not shown). The inventory management system 700 tracks such activities.

The attended DC 710 is generally larger (holds more inventory items) than an FSF 708, thereby resulting in a lower warehousing cost for inventory kept in a DC 710, as compared to that kept in an FSF 708. Generally, there are fewer DCs 710 in an IMS's distribution system. They are often strategically located near overnight parcel services (so-called “end of runway” locations) so that items may be rapidly shipped to other IMS-controlled facilities. The DC 710 operates primarily to distribute items to FSFs 708, unattended facilities 722, and other IMS-controlled facilities. A DC 710 may serve as a point for the consolidation of return items that have been returned to other IMS-controlled facilities 702, 704, 706, 708 or shipped directly to the DC 710 using an intelligent return shipping label. Once received at the DC 710, the return items may be inspected, repaired, sent to other IMS-controlled facilities 702, 704, 706, 708, returned to vendors 724, sent to other parties (not shown), or destroyed. One or more interface devices 720 to the inventory management system 700 allows the entering of information about inventory items, reviewing information, and performing other inventory tracking and management functions.

Other embodiments of IMS-controlled facilities that are not shown in FIG. 7 include an attended facility having an attended service area 732. The attended facility includes an unattended facility 722 that is utilized in a return system 736 for return items. Items are retrieved by technicians 738 at the attended service area 732 from IMS personnel 728. Return items may be delivered to IMS personnel 728 at the attended service area 732, or they may be placed in the secure areas of the unattended facility 722.

A third-party vendor 724 as illustrated in FIG. 7 may be provided with some level of access to the inventory management system 700 via an interface device 720. This access may be provided, for example, as part of an Electronic Data Interchange (EDI) system for the automatic ordering of additional inventory items. The access provided to a vendor 724 may be limited for security and operational purposes, but may include information about the third-party's inventory in order to expedite ordering, receiving, and distributing such items. Likewise, customers (not shown) may be provided access to the inventory management system 700 to view the status of ordered items, technician 738 efficiency, etc. This access also may be limited by the IMS using standard computer password-related security settings.

Cross-Docked Orders

As previously described, “cross-docking” occurs when items arrive at the receiving area of the IMS-controlled facility and are immediately be made available for pick-up by the technician without ever entering the physical inventory of the IMS-controlled facility. This process reduces the handling of items by IMS personnel and expedites a technician's access to the ordered items.

In embodiments of the invention, the inventory management system 700 is integrated between IMS-controlled facilities 702, 704, 706 with co-located unattended facilities 722, FSFs 708, DCs 710, and other stand-alone unattended facilities (not shown). For items shipped from the same distribution network (i.e., facilities associated with the same integrated inventory management system 700), such as from a DC 710 or another FSF 708, where all inventory information resides in the inventory management system database 716 and is linked, the staging process can be streamlined into just one identification code, referred to as an “order identifier.” The order identifier is assigned by the inventory management system 700 at the IMS-controlled facility from which the order is being shipped. One or more item identifiers associated with the ordered items are linked with the order identifier to form an order identified by the unique order identifier. This linking between order identifiers and item identifiers occurs in the inventory management system 700. It may occur, for example, by scanning barcodes on each item that comprise the order (item identifiers), and then scanning a unique barcode that forms the order identifier, and the inventory management system links the order identifier to the item identifiers. In other embodiments, the item identifier and the order identifier may be one or more of alphanumeric characters entered manually, radio frequency identification tag, codes magnetically, optically or electronically coded, electronic transmissions, digital signatures, sounds, colors, lights or any other means of uniquely identifying the items and the order.

As previously stated, the item staging process may be streamlined by having an order identifier linked to items having item inventory information in the inventory management system database 716. Generally, these shipments occur between IMS-controlled facilities, but such shipments may be from a vendor 724, customer, or IMS-controlled facility. For example, an IMS-controlled facility receiving an item shipment from another IMS-controlled facility, where the shipment has an order identifier, will merely enter the order identifier into the inventory management system 700 at the IMS-controlled facility, associate the order with one or more secure areas of one or more unattended facilities 722, and place the (now) cross-docked orders directly into the selected secure areas of the unattended facility 722, thereby staging them for pick up. This staging activity indicates that the order has been received by the receiving IMS-controlled facility and is ready for pick-up. The inventory management system 700 links the order identifier to the information detail about the items that comprise the order to provide tracking information of each individual item in the order.

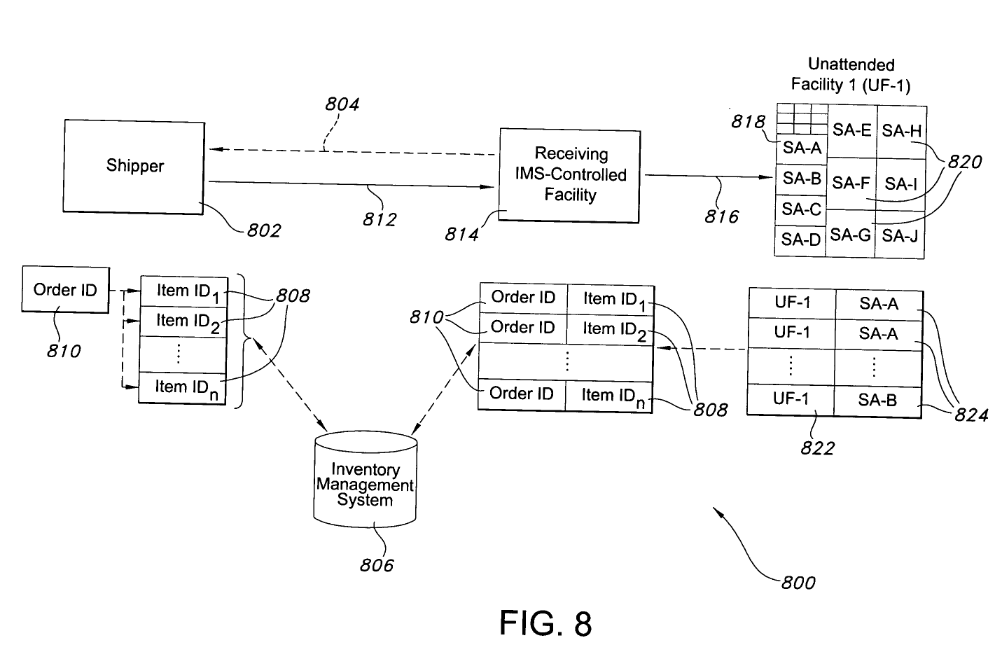

An embodiment of the process 800 of transferring items associated with an order identifier is illustrated in FIG. 8. In FIG. 8, solid lines represent the actual movement of physical items, while dashed lines represent the exchange of information. A shipper, as indicated in FIG. 8, may be another IMS-controlled facility such as, for example a DC or a FSF, a third-party vendor, or in some instances, a customer. A shipper 802, upon receiving a request 804 to ship an order of items, obtains the items that comprise the order. Each item is previously identified to the inventory management system 806 with detailed descriptive, financial and tracking information about each item residing on the inventory management system database 716. Each item has been assigned a unique item identifier 808 by the inventory management system 806. The shipper 802 obtains a unique order identifier 810 from the inventory management system 806. The order identifier 810 is then linked to each item identifier 808 of each item that comprises the order. The shipper 802 performs the entry of linking information (by scanning, etc.), while the actual linking occurs in the inventory management system 806. The ordered items are then shipped 812 from the shipper 802 to the receiving IMS-controlled facility 814. IMS personnel at the receiving IMS-controlled facility 814 place 816 the items in one or more unattended facilities 818. The items are placed in one or more secure areas 820 of the unattended facilities 818. If the order will fit within a single secure area 820, then only the order identifier 810 is scanned or otherwise entered into the inventory management system 806, where the order identifier 810 and the item identifiers 808 of the items that comprise the order are associated with an unattended facility identifier 822 and a secure area identifier 824 of the secure area 820 of the unattended facility 818 in which the order has been placed.

In FIG. 8, if the items that comprise the order are placed in more than one unattended facilities 818 at the receiving IMS-controlled facility 814 or if the ordered items are placed in more than one secure area 820 of a single unattended facility 818, then the order identifier is associated with more than on secure area 820 or each item identifier 808 may be scanned or otherwise entered into the inventory management system and associated with the identifier 822 of the unattended facility 818 and the identifier 824 of the secure area 820 into which the items are placed. Associating the order identifier 810 and/or the item identifiers 808 with one or more unattended facility identifiers 822 provides indication to the inventory management system 806 that the order has been received by the receiving IMS-controlled facility 814, and provides item tracking information.

For items shipped directly from non-integrated third-party vendors (i.e., vendors not integrated into the inventory management system), all inventory information will need to be entered since it is the first time the part will enter the inventory system. However, with the integration between the inventory management system 806 and the control system of the unattended facility 818, the number of status updates on both systems can be reduced. This could limit data entry error caused by redundant data entry as well. Integrating the inventory management system 806 and the control system of the unattended facility automatically updates the records of the inventory management system 806 when discrete events occur, such as, for example, when the order shipped from the shipper 802, when it was received by the IMS-controlled facility 814 (scan or otherwise enter order identifier 810 into the inventory management system), when the order is staged and placed in an unattended facility 818 (associate an order identifier 810 with one or more unattended facility identifiers 822 and secure area identifiers 824), and when the order is picked up by a technician (associate a technician's access code with the secure areas 820 containing the ordered items and the unattended facility's 818 control system records when the passcode is used to access the secure areas 820 to retrieve the items and transfer this information to the inventory management system 806).

Return System

As previously described herein, during peak hours at IMS-controlled facilities, some technicians may return items at the same time they are picking up items. An unattended return system will reduce both the queue length and the number of return items that may gather at an attended service area. An unattended return system also provides flexibility for IMS personnel to efficiently perform processing of return items. In prior art return systems, each technician was served one at a time as the technicians are queued and wait their turn to approach the attended service area for returning items. In embodiments of the present invention, return items from multiple technicians are accumulated at a secure area for processing in a batch at a later time. This gives additional flexibility to schedule tasks at attended IMS-controlled facilities. Furthermore, as IMS personnels' tasks become scheduled at such attended IMS-controlled facilities, the return system embodiments of the present invention allow the IMS personnel to perform their tasks with less distractions caused by technicians returning items.

Therefore, embodiments of the present invention provide for convenient and efficient systems and methods to distribute items to technicians and to receive return items. Such systems and methods may be used to distribute service parts to repair technicians by an inventory management service, though their use is not limited to this application. The concurrent use of one or more unattended facilities with an attended IMS-controlled facility enables the IMS to levelize staffing requirements and benefits the customer in reduced delay time for retrieving and depositing items by technicians. Many of the embodiments and figures referenced herein generally disclose one unattended facility co-located at an attended IMS-controlled facility; however, there may be multiple unattended facilities at such locations and the IMS-controlled facilities are not necessarily independent buildings or areas owned or leased by the IMS as they may be located on a customer or vendor's premises, yet operated (and thus, controlled) by the IMS.

In the embodiments of the invention, along with the use of intelligent authorized return shipping labels, return items that are in a technician's “loan file” and other return items are generally returned more promptly than in prior art systems. This faster cycle time, along with the knowledge that the IMS has because orders are generally placed with the IMS prior to pick up by a technician and the use of DCs (used to supply FSFs with items) that are located proximate to an overnight parcel delivery service's shipping facility allow the IMS to have less inventory at the FSFs because ordered items may be taken from the FSF's inventory, from undamaged or unused return items or shipped in to the FSF from a DC, a third-party vendor, another FSF, etc., before the time for pick up. Because space in an FSF is limited, storage space in a FSF at a premium. Generally, on a cost per square foot basis, storage space in a FSF is more expensive than space in a DC. This is because of the purchase/rental cost of FSF space is generally greater (on a square foot basis) than that of a DC and there are economies of scale and efficiencies experienced in the operation of a DC that are not enjoyed by FSFs. Therefore, reducing on-hand inventory in the FSFs reduces the overall cost of inventory management. Furthermore, the use of overnight parcel delivery services allows a customer to place an order later in the evening the day before it is needed or will be picked up at an FSF. Cross-docking of such ordered items reduces handling and other delays that may be caused by IMS processing. Advance knowledge of orders also allows FSFs to stage the ordered items without having to retrieve each order as a technician in a face-to-face situation picks it up. Finally, the use of unattended facilities proximate to attended facilities allows the orders to be staged and retrieved unattendedly from the unattended facilities and allows items to be returned without assistance from IMS personnel. These unattended aspects of the embodiments of the present invention help levelize labor-staffing at IMS-controlled facilities and reduce wait times for those technicians desiring personal service.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for the management of service parts, comprised of:
an attended facility operated by an inventory management service and having an attended service area where service parts may be distributed and returned;
an unattended facility associated with the attended facility and capable of containing a plurality of service parts;
an inventory management system that is associated with the attended facility and the unattended facility and is capable of tracking service parts in the inventory of the attended facility, service parts that have been placed in the unattended facility, service parts that have been distributed from the attended facility and the unattended facility and service parts that have been returned to the attended facility and the unattended facility,
the unattended facility having one or more secure areas, a processor and a data entry device, with each secure area having a door and a lock, wherein the processor is programmed to open one or more locks when a passcode is entered into the data entry device.

2. The system of claim 1, wherein the unattended facility is located within the attended facility and access to the unattended facility is provided at times when the attended service area is available and when the attended service area is not available.

3. The system of claim 2 further comprising a returns system, wherein service parts may be returned to the attended service area and an unattended returns area.

4. The system of claim 3, wherein the unattended returns area is incorporated into the unattended facility.

5. The system of claim 3, wherein the unattended returns area is located within the attended facility but separate from the unattended facility.

6. The system of claim 3, wherein access to the unattended returns area is provided at times when the attended service area is available and when the attended service area is not available.

7. The system of claim 1, wherein the unattended facility is located proximate to the attended facility and access to the unattended facility is provided at times when the attended service area is available and when the attended service area is not available.

8. The system of claim 7 further comprising a returns system, wherein service parts may be returned to the attended service area and an unattended returns area.

9. The system of claim 8, wherein the unattended returns area is incorporated into the unattended facility.

10. The system of claim 8, wherein the unattended returns area is located within the attended facility but separate from the unattended facility.

11. The system of claim 8, wherein access to the unattended returns area is provided at times when the attended service area is available and when the attended service area is not available.

12. An unattended item distribution and return system incorporated into an inventory management service's attended facility having an attended service area, the unattended distribution and return system comprised of:
an unattended facility having one or more secure areas, one or more processors, and a data entry device, with the secure areas having a lockable door, the lock on the door connected to the processor such that the processor may be programmed to open one or more locks when a passcode is entered into the data entry device and items are placed by inventory management service personnel and are held for pick-up by technicians;
one or more servers connected to the one or more processors of the unattended facility, wherein the one or more servers are capable of causing the notification of technicians that items are available for pick-up in the secure areas of the unattended facility;
an inventory management system operating on the one or more servers and having information about items that are in the inventory of at least the inventory management service's attended facility, the inventory management system integrated with the unattended facility such that information about items placed in the secure areas of the unattended facility is not required to be entered into the data entry device of the unattended facility if said information has previously been entered into the inventory management system;
a database associated with the inventory management system, wherein the database is used to record the pick-up or placement of items in the secure areas of the unattended facility and update an item's inventory records accordingly; and
one or more interface devices associated with the inventory management system, wherein the interface devices may be used to enter and view information about the items in the inventory of the inventory management service.

13. The system of claim 12, wherein inventory information of one or more items may be entered into the data entry device of the unattended facility, the inventory information of the one or more items is used to update the database of the inventory management system.

14. The system of claim 12 further comprising a returns system, wherein items may be returned to the attended service area and an unattended returns area.

15. The system of claim 14, wherein access to the unattended returns area is provided at times when the attended service area is available and when the attended service area is not available.

16. The system of claim 14, wherein the unattended returns area is incorporated into the unattended facility.

17. The system of claim 14, wherein the unattended returns area is located within the inventory management service's facility but separate from the unattended facility.

18. A method for the distribution and receipt of returned items by an inventory management service, comprising:
providing an unattended facility comprised of one or more secure enclosures at a location that is proximate to an attended facility having an attended service area and the attended facility controlled by the inventory management service, the unattended facility comprised of one or more secure enclosures with each secure enclosure having a door with a lock; a data entry device; and a processor wherein the processor is configured to send a signal that locks or unlocks the lock on the door when a passcode is entered into the data entry device, the unattended facility connected to an inventory management system via a network;
maintaining an inventory of items in one or more storage facilities controlled by an inventory management service with the inventory management system having information about the inventory of items;
placing one or more items within at least one of the secure enclosures of the unattended facility;
allowing any one of a plurality of customers to access the items, as needed;
updating the information about the inventory of items in the inventory management system when the items are accessed and taken from the unattended facility.

19. The method of claim 18, further comprising:
receiving from one or more customers a request for an order comprising of one or more of the items;
responding to a customer requesting delivery of the order by placing the one or more items that comprise the order in one or more of the secure enclosures of the unattended facility;
securely maintaining the one or more items within the secure enclosures of the unattended facility until the order is retrieved up by the customer; and
allowing the customer to access the one or more items within the unattended facility.

20. The method of claim 19, further comprising providing a notification to the customer that the items comprising the customer's order have been placed in one or more secure enclosures of the unattended facility.

21. The method of claim 20, wherein providing the notification to the customer that the items comprising the customer's order have been placed in one or more secure enclosures of the unattended facility includes providing a passcode in the notification and said passcode is used by the customer to gain access to the secure enclosures of the unattended facility so that the customer may retrieve the items comprising the order.

22. The method of claim 21, wherein the notification to the customer that the items comprising the customer's order have been placed in one or more secure enclosures of the unattended facility is comprised of a notification that is chosen from the list consisting of an electronic page to a wireless electronic paging device, an electronic mail message, and a telephonic transmission sent to the customer.

23. The method of claim 21, further comprising concurrently making items available to certain customers at the attended service area at the attended facility and receiving items being returned by certain customers at the attended service area.

24. The method of claim 21, further comprising making access to the unattended facility available when access to the attended service area is unavailable and making access to the unattended facility available when access to the unattended facility is available.

25. The method of claim 18, further comprising:
providing a returns system with an unattended returns area, wherein items may be returned to the attended service area and the unattended returns area.

26. The method of claim 25, further comprising providing access to the unattended returns area at times when the attended service area is available and when the attended service area is not available.

27. The method of claim 25, wherein when providing the returns system with an unattended returns area, the unattended returns area is incorporated into the unattended facility.

28. The system of claim 25, wherein providing a returns system with an unattended returns area, the unattended returns area is located within the inventory management service's attended facility but separate from the unattended facility.

29. A method for the distribution and receipt of returned items by an inventory management service, comprising:
providing an unattended facility comprised of one or more secure enclosures at a location that is within an attended facility having an attended service area and the attended facility controlled by the inventory management service, the unattended facility comprised of one or more secure enclosures with each secure enclosure having a door with a lock; a data entry device; and a processor wherein the processor is configured to send a signal that locks or unlocks the lock on the door when a passcode is entered into the data entry device, the unattended facility connected to an inventory management system via a network;
maintaining an inventory of items in one or more storage facilities controlled by an inventory management service with the inventory management system having information about the inventory of items;
placing one or more items within at least one of the secure enclosures of the unattended facility;
allowing any one of a plurality of customers to access the items, as needed;
updating the information about the inventory of items in the inventory management system when the items are accessed and taken from the unattended facility.

30. The method of claim 29, further comprising:
receiving from one or more customers a request for an order comprising of one or more of the items;
responding to a customer requesting delivery of the order by placing the one or more items that comprise the order in one or more of the secure enclosures of the unattended facility;
securely maintaining the one or more items within the secure enclosures of the unattended facility until the order is retrieved up by the customer; and
allowing the customer to access the one or more items within the unattended facility.

31. The method of claim 30, further comprising providing a notification to the customer that the items comprising the customer's order have been placed in one or more secure enclosures of the unattended facility.

32. The method of claim 31, wherein providing the notification to the customer that the items comprising the customer's order have been placed in one or more secure enclosures of the unattended facility includes providing a passcode in the notification and said passcode is used by the customer to gain access to the secure enclosures of the unattended facility so that the customer may retrieve the items comprising the order.

33. The method of claim 32, wherein the notification to the customer that the items comprising the customer's order have been placed in one or more secure enclosures of the unattended facility is comprised of a notification that is chosen from the list consisting of an electronic page to a wireless electronic paging device, an electronic mail message, and a telephonic transmission sent to the customer.

34. The method of claim 32, further comprising concurrently making items available to certain customers at the attended service area at the attended facility and receiving items being returned by certain customers at the attended service area.

35. The method of claim 32, further comprising making access to the unattended facility available when access to the attended service area is unavailable and making access to the unattended facility available when access to the unattended facility is available.

36. The method of claim 29, further comprising:
providing a returns system with an unattended returns area, wherein items may be returned to the attended service area and the unattended returns area.

37. The method of claim 36, further comprising providing access to the unattended returns area at times when the attended service area is available and when the attended service area is not available.

38. The method of claim 36, wherein when providing the returns system with an unattended returns area, the unattended returns area is incorporated into the unattended facility.

39. The system of claim 36, wherein when providing a returns system with an unattended returns area, the unattended returns area is located within the inventory management service's attended facility but separate from the unattended facility.

40. A method for the return of an item to an unattended facility, comprising:
providing an unattended facility located proximate to an attended facility controlled by an inventory management service, the unattended facility comprised of one or more secure enclosures with each secure enclosure having a door with a lock; a data entry device; and a processor wherein the processor is configured to send a signal that locks or unlocks the lock on the door when a passcode is entered into the data entry device;
returning an item to the unattended facility and entering return information about the return item into the data entry device;
associating the item with a return identifier, wherein the return identifier contains information about the return item;
placing the item in one or more secure enclosures of the unattended facility and closing and locking the door of the secure enclosures;
transmitting the return information from the unattended facility to a server via a network; and
utilizing the return information to process the item prior to the item's retrieval from the unattended facility by personnel associated with the inventory management service.

41. The method of claim 40, further including the steps of:
securely maintaining the items in the secure enclosures of the unattended facility until they are retrieved;
accessing the secure enclosures of the unattended facility that contain the items by entering the passcode into the data entry device; and
retrieving the items from the unattended facility and transporting the items to a facility controlled by the inventory management service.

42. The method of claim 41, further comprising creating said return identifier at the unattended facility.

43. The method of claim 42, wherein when creating said return identifier at the unattended facility, the return identifier indicates a status of the return items and the status may be selectively chosen.

44. The method of claim 43, further comprising creating a receipt for the item placed in the unattended facility.

45. A method of managing the labor resources of an inventory management service's attended facility, comprising:
providing an unattended distribution facility proximate to the attended facility such that an item ordered by a technician may be placed in the unattended distribution facility prior to the technician's arrival at the attended facility by inventory management service personnel and the technician may retrieve the ordered item without the assistance of the inventory management service's personnel;
providing an unattended returns facility proximate to the attended facility such that the technician may return items without having to place the items with the inventory management service personnel; and
providing technicians access to the unattended distribution facility and the unattended returns facility at times when inventory management service personnel are not available in the attended facility.

46. The method of claim 45, wherein when providing the unattended distribution facility and the unattended returns facility proximate to the attended facility, the unattended returns facility is incorporated into the unattended distribution facility.

47. A method of utilizing an unattended distribution and return system by an inventory management service, comprising:
incorporating an unattended item distribution system into an attended facility controlled by the inventory management service;
incorporating an unattended item returns system into the attended facility controlled by the inventory management service;
providing access for a customer to retrieve an ordered item from the unattended item distribution system;
providing access for the customer to place a return item in the unattended item returns system;
operating an attended item distribution area and an attended item returns area at the attended facility concurrently with the unattended item distribution system and the unattended item returns system during certain time periods, wherein certain customers may retrieve the ordered item at the attended item distribution area or return the return item at the attended item returns area;
operating the unattended item distribution system and the unattended item returns system during certain time periods when the attended item distribution area and an attended item returns area at the attended facility are not available, wherein certain customers may retrieve the ordered item at the unattended item distribution system or return the return item at the unattended item returns system; and
electronically linking an inventory management system with a control system associated with the unattended item distribution system so that ordered items taken from an inventory of items in the attended facility may be tracked when the ordered items are placed in the unattended item distribution system and when they are removed from the unattended pick-up and return system.

48. A method of utilizing an inventory management system to track items that have been provided to technicians by an inventory management service, comprising:
identifying items with a unique item identifier;
entering the item identifier into the inventory management system along with a location of the item;
updating the location of the item in the inventory management system as necessary if the item is re-located;
distributing the item to a technician;
recording a distribution date that the item was distributed to a technician and an identifier associated with the technician in the inventory management system;
monitoring the time from the distribution date that the item is kept by the technician with the inventory management system; and
notifying the technician for the item if the item is not returned to the inventory management service within a certain amount of time from the distribution date.
